(19) United States
(12) Patent Application Publication
(10) Pub. No.: US 2005/0200480 A1
(43) Pub. Date: Sep. 15, 2005

(54) System and method for monitoring the occurrence of situational and environmental events using distributed sensors

(76) Inventors: Jay David Caras, King County, WA (US); Thomas James Nault, King County, WA (US)

Correspondence Address: JAMES L. DAVISON, 19822 226TH AVENUE N.E., WOODINVILLE, WA, 98077, US

(21) Appl. No.: 11/008,345

(22) Filed: Dec. 8, 2004

Related U.S. Application Data
(60) Provisional application No. 60/528,137, filed on Dec. 9, 2003.

(51) Int. Cl. G08B 1/08

(52) U.S. Cl. 340/539.22; 340/870.01

(57) ABSTRACT

A system and method relating to the monitoring of environmental and/or situational events by the use of distributed sensors and sensor control modules. The sensor control modules contain means for self-location and wireless communication. When the sensor control module, using its distributed sensors, determines an event has occurred that matches either a predetermined or dynamically set limit, a wireless notification is made to a central collector. The central collector analyzes the data received from one or more sensor control modules and then, if appropriate, notifies a remote facility.

### CROSS-REFERENCE TO RELATED APPLICATIONS

This application claims the benefit of provisional application Ser. No. 60/528,137 filed 2003 Dec. 9.

### BACKGROUND

1. Field

The present invention relates to the monitoring of environmental and/or situational events by the use of distributed sensors, said sensors with a self-locating capability. When the distributed sensors determine an event has occurred that matches either a predetermined or dynamically set limit, a notification is made to the appropriate remote entity. The ability to dynamically set sensor notification limits is more fully explained later in this disclosure

2. Description of Related Art

There are many types of monitoring systems now on the market. Monitors are used to sense the potential of volcanic eruptions, to sense the presence of people or animals, to detect radiation or harmful gasses or almost any other physical condition or phenomena capable of being sensed and measured. There may be situations where one or more sensors need to have a precise known location but where the exact placement of these sensors may be difficult or even impossible. The present inventions allows one or more sensors to be placed in an approximate location and said sensors then self-determine and communicate their exact location to a central monitor.

### OBJECTS AND ADVANTAGES

Accordingly several objects and advantages of the present invention are:
1) having the ability to scatter sensors in a general location and having said sensors then determine exactly where they are and then communication that exact location to a central monitoring platform;
2) having the ability to scatter sensors in a general location whereupon the sensors having been scattered, can, if their location shifts, communicate that shifting location to a central monitoring platform; and
3) having the ability to use only one or perhaps several, of a larger plurality of sensors, with these said one or several having the capability of determining their exact location and then determining and communicating the location of other sensors that do not have the ability to self-determine their location.
   Another advantage that will become apparent is the ability to use multiple relatively inexpensive sensor control modules, with limited processing power which in turn communicate with a central collector module that sits at the top of the hierarchy in processing power and communication capability.

### SUMMARY

In accordance with the present invention a distributed intelligence monitoring nd notification system and method is disclosed. The system and method uses one or more relatively inexpensive sensors of limited capability feeding sensor data to sensor control modules. These sensor control modules have the capability to receive multiple inputs from one or more sensors and to analyze these inputs against a predetermined or dynamically set criteria before communicating their analysis up a hierarchical chain. At the top of the chain is a central collector module. The central collector module has the greatest amount of processing and communication power. The central collector module can analyze the inputs from the sensor control modules and, using its processing power, analyze the data received, and if certain criteria is met, wirelessly communicate the results of its analysis to a remote base location. Since the sensors, sensor control modules and central collector module may be distributed or scattered without being placed in a predetermined and known location, they possess the capability of self-location. The present invention, in the preferred mode, uses Global Positioning System (GPS) radio signals allowing the components of this system to determine their position within the limits of the GPS systems capability. The term “distributed” means that there are a number of sensors, sensor control modules and central collector modules located around a specific area wherein the sensors, sensor control modules and central collector modules are working together to gather specific information about their environment. The term “scattered” reflects a number of sensors, sensor control modules, and central collector modules, not placed in exact locations but rather spread over an area, without knowing their precise placement. Scattered is a subset of the term distributed.

### BRIEF DESCRIPTION OF THE DRAWINGS

The invention is further described in connection with the accompanying drawings, in which:

FIG. 1 shows a sensor communicating with a sensor control module.

FIG. 2 shows a tree of sensor control modules communicating with the central collector.

FIG. 3 demonstrates the capability of sensors without a GPS system to be accurately located.

FIG. 4 shows how the orientation between two objects may be determined.

### DETAILED DESCRIPTION OF THE PREFERRED EMBODIMENT

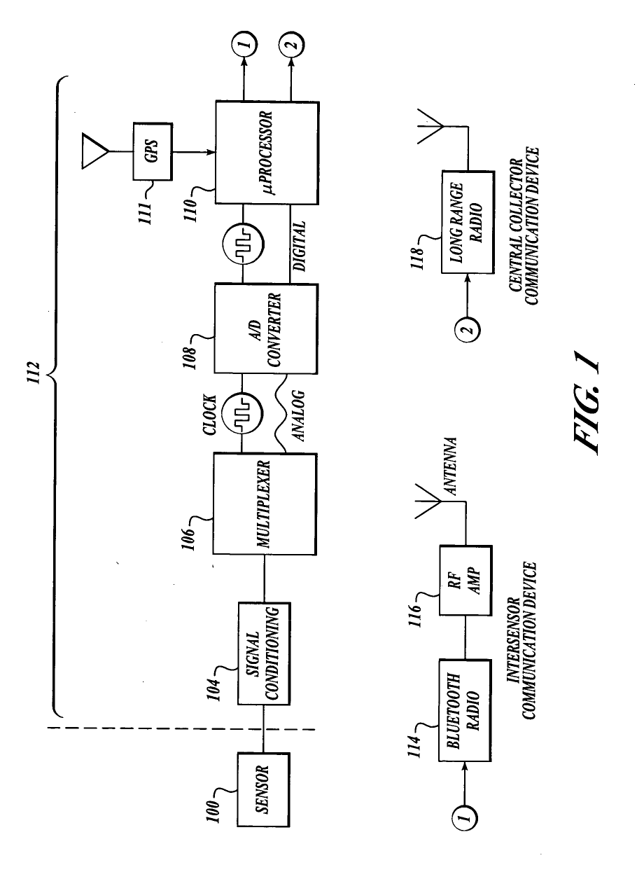

FIG. 1 shows the schematic layout of a sensor system that includes a sensing device (sensor) 100 attached to a sensor control module 112. The sensing devise 100 has a form factor allowing it to be firmly attached to or socketed within the sensor control module 112. The sensor control module is capable of receiving and retaining multiple sensing devices. The present invention allows the sensor control modules to be generally located in an area without the user actually knowing their exact placement. The sensor system is able to determine its own location within the limits of the attached Global Positioning System (GPS) system 111. The sensor control module then communicates with other sensor control modules in the area that make up the sensor network. It is possible to have all the sensor control modules GPS capable but have only the modules necessary to locate other modules by using signal strength and triangulation using its GPS system at a time. This allows maximum battery life of the systems if only the minimum number of modules find it necessary to use their GPS devices. If the distributed sensors control modules are unlikely to move after initial placement then their location needs only to be determined once. Each sensor control module incorporates a wireless communication device. This wireless communication device allows each sensor control modules to be uniquely identified. The wireless communication device in the preferred embodiment uses the Bluetooth radio standard. The Bluetooth standard gives the radio the ability has the capability to determine the lowest radio power necessary to communicate with the next appropriate sensor control module in the network. The sensors control modules are capable of self-determining the communication hierarchy necessary for each sensor control module to be capable of communicating its data up the hierarchy eventually to a central collector module or sensor control module capable of long range communication to the central control platform.

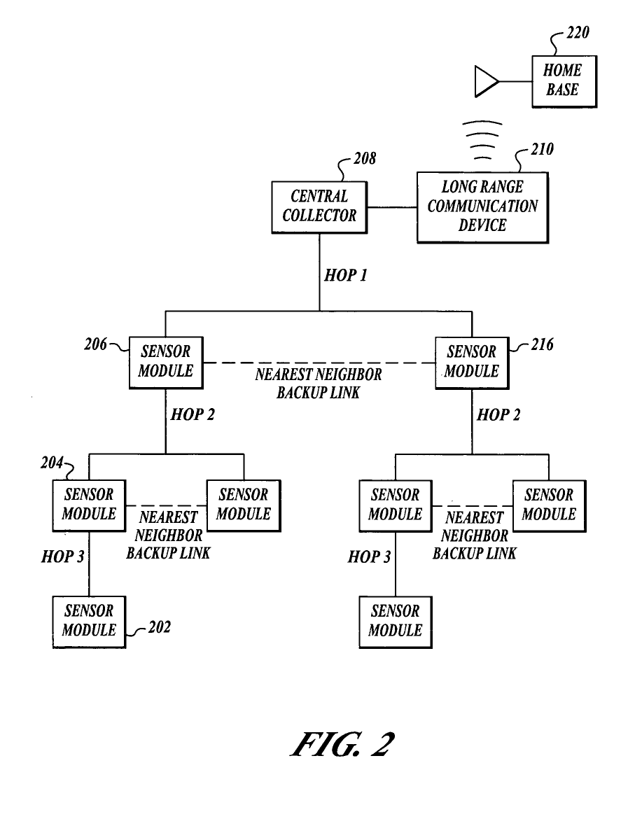

A detailed description of FIG. 1 follows. A sensor 100 communicates its output to a sensor control module 112. The sensor control module is comprised of a signal conditioner 104, a multiplexer 106, an analog to digital (A/D) converter 108, a central processing unit (CPU) 110, a Bluetooth radio 112, a RF amplifier 114, an antenna 116, and a power supply 118. Some sensor control modules will also be equipped with the optional GPS device 111. The central collector 208 as shown in FIG. 2 is at the top of the network hierarchy and in the preferred embodiment possesses the greatest amount of processing power and memory. However as a back-up device to this central collector, any number of the lower echelon sensor control modules may also be equipped with a long range wireless communication device. This hierarchy of devices, from simple sensors to more sophisticated sensor control modules to the even greater capability central collector keeps the cost of deploying these devices down and provides reliability to the overall network. The simpler devices in the network are not only less expensive but also more rugged due to their relative lack of sophisticated electronics. The Bluetooth radio has characteristics that make it the preferred short range wireless device at this time but the technology is advancing so fast that they may be other wireless transmitting systems supplanting the Bluetooth system in the future. In some embodiments the device making up the present invention may not have line power from which to operate. In those instances the devices may be powered by battery. The battery may in turn be a one time use type or a rechargeable type using, for example, a solar panel. Devices obtaining their power from line voltage may also have emergency battery or generator backup power capability in the case of losing the line voltage. Multiple sensors are capable of reporting to a single sensor control module. The sensor's 100 function is to predictably convert specific conditions, such a temperature, presence of gas, levels of liquid and many others, to electrical signals. The signal conditioner 104 adapts the sensor signal for input into the multiplexor 106 by supplying filtering, bias and reference signals to the sensors. The multiplexor 106 can take multiple signals and combine them into one output in such a manner that the signals can be later separated into individual signals again later in the process. The AND converter 108 takes the analog signal from the multiplexor and converts it into a digital signal for processing in the central processing unit (CPU) 110. The CPU has a number of different functions. It can compare current sensor signals to past sensor signals that it has collected and stored in memory. It can initiate communication with other sensor modules or with the central control module (CCM). The sensor control module CPU 110 can also set and reset sensor signal limits. The sensor control module is also in two-way communication with the central control module. The sensor control module can also act as a backup control module in the control module tree as shown in FIG. 2. If a sensor control module fails, the backup sensor control module, either predetermined or dynamically chosen, can assume the responsibilities of the failed or non-responsive sensor control module. This way the backup module can receive and analyze signals from the sensors that used to report to the failed or non-responsive module. The preferred embodiment using the Bluetooth radio has the added benefits of relatively low cost, built-in data security, low power usage, a compact footprint, and widespread acceptance and availability. Another feature of the Bluetooth radio is the scaling power output. If the radio receives no response from the unit that it directing its signal to, it has the capability to step its increase in its signal strength (within limits), with the concomitant increased power usage, until it receives a response. This capability to match its power to its needs, depending on a variety of conditions, allows it to use the minimum power necessary for optimal communication capabilities. For example, the radio may incrementally increase power, starting from a minimum level, until communication is established with its designated target. However as previously mentioned there are other radio standards that would be fully satisfactory to meet the requirements of the present invention. Although this disclosure mentions extensive use of wireless communication between devices it is entirely possible to use wired technology as well. There are many examples in use today where thin strong wires are deployed to remote devices in order to carry signals. Although the sensor control modules use the before mentioned wireless technology it is possible to attach the actual sensors to the sensor control modules using said thin wires. For a sensor network deployed by air it makes for a reduced impact if the sensor control modules can be made lighter by having the sensors themselves wired to these control modules rather than socketed into them.

The central collector, being in two-way communication with both the sensor control modules and the remote facility, can set and reset the sensor notification limits.

As shown in FIG. 2, the lower level sensor control module 202 communicates with the next level sensor control module 204 (hop 3), which, in turn, communicates with the next device (in this case the central collector 208, using hop 1) above it in the hierarchy. The central collector 208 provides duplex communication with the sensor control modules at the hop 1 level, 206 and 216. The Bluetooth radio standard gives the device the ability to dynamically exchange communication addresses (bind) with each other. In the present embodiment the devices, before deployment, are brought into proximity with each other and a manual command is giver to each device to exchange addresses. Each device has already been given a unique address, from a sequence of unique addresses, as designated by the Bluetooth SIG group. The binding gives each device permission to communicate with each other. Any other Bluetooth radio in the proximity of the two authorized radios does not have permission to communicate with them and therefore has no effect on them.

For sensitive information the sensing levels communicated to the central control platform may be encrypted prior to sending. Also to save power and reduce power it is possible “burst” communicate to the central control platform.

In the present case we can tier the communications by having the hop 1 devices 206 as shown in FIG. 2 bind with the central collector 208; have the hop 2 devices 204 bind with the hop 1 devices 206 (note that the hop 2 devices cannot communicate directly with the central collector), and have the hop 3 devices 202 bind with the hop 2 204 devices. At regular intervals, the home collector 208 transmits a command to the hop 1 sensor control modules 206 and 216 putting them in a communication mode of operation. All the hop 1 devices (sensor control modules) then respond to the central collector 208 with their ID number and received signal strength indicator level (RSSI). After the collector has recorded the ID number and RSSI level of the hop 1 devices 206 and 216, the collector directs the hop 1 devices to discover the hop 2 devices capable of communicating with the hop 1 devices (but not directly with the collector). The hop 1 devices then receive the ID numbers and RSSI levels from the hop 2 devices. The hop 1 devices then forward that information to the central collector 208. This process is then repeated down the chain until all the devices have been discovered and all the necessary information has been forwarded to the central collector. With this information in hand the central collector 208 calculates an optimized tree architecture consisting of the primary direct routing (minimum number of hops) for each device along with calculating a secondary route in the event the primary route becomes disrupted for any reason. The central collector 208 recalculates and reconfigures the routing scheme of the network each time it communicates with the devices in the network.

In an alternative embodiment, prior to deployment, the radio devices are bound to each other radio device contemplated to be in the network. This is especially important when the devices are to be deployed in a manner wherein the exact location of each device with a radio is not known in advance. Upon deployment the devices with radios send a signal to every other device with a radio within range. The devices with radios then calculate the number of other devices in range with them, their signal strength and their proximity to the central collector. A hierarchy of devices is then decided upon, based on the signal strength criteria to minimize the power requirement of each device and also based on the spreading out the communication workload, again to minimize the power dissipation of any one device.

This dynamic nature of the network allows it to easily adapt to any device that is added to, or moved within the network. In many applications of this network the devices are moving relative to each other and the dynamic nature of the network configuration keeps the network optimized.

The communication protocol used in the preferred embodiment is TCP/IP. TCP stands for Transmission Communication Protocol and IP stands for Internet Protocol. TCP/IP is the well known Internet communication protocol. The use of this protocol ensures an interoperability of all the major operating systems including WINDOWS, LINUX and UNIX, among many others. WINDOWS, LINUX and UNIX are trademarks owned by their respective companies. These operating systems along with many others support the TCP/IP protocol. The TCP/IP protocol also ensures that most PDA's, laptops and cell phones can communicate and interact with the central collector and individual sensor control modules.

The central collector in the preferred embodiment also maintains a long range communication device along with its shorter range Bluetooth radio. In the circumstances in which landline or wired communication is not possible then the central collector can use a relatively high powered radio to communicate with a base station. The base station is typically the home base of the distributed network. The base station has the capability to monitor the data sent by the central collector, collects and analyzes this data and can take any measures deemed to be appropriate from said data. Of course the base station may be monitoring a series of distributed sensor networks, wherein any individual network data may be a part of a mosaic of data that is only meaningful when combined into an overall picture.

Some individual sensor control modules may also contain a long range communication device along with its shorter range Bluetooth radio. This ensures continued communication in the event that the central control module becomes inoperable. A sensor control module may be programmed to assume overall responsibility for the network in the event that the central collector fails to initiate communication with its directly linked sensor control modules after a certain number of regularly scheduled contact times are missed.

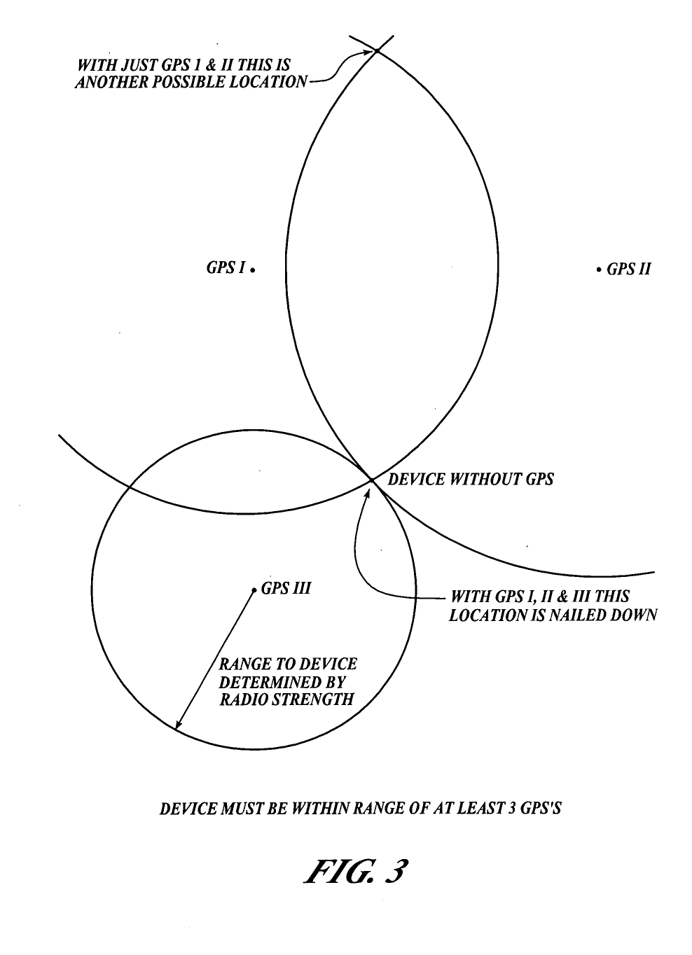

FIG. 3 shows a schematic layout of a distributed sensor networked system that may be located generally in an area without knowledge of each devices specific location. The sensor network system is able to determine, not only the location of each device in the network via individual device GPS systems, but also the location of devices that were distributed without GPS capability or have lost their GPS capability. The sensor system is able to determine its own location within limits of the GPS system and then communicate with other sensors scattered in the general area. It is also possible to have all the system devices GPS capable but only use a minimum of three devices at a time to save the power of the other devices. This allows for maximum battery life of a device if only three devices determines their individual locations then communicate the locations of other devices they have found by triangulation and signal power. If the distributed devices are unlikely to move relative to each other then the location of the devices need only be determined once. The sensor control module's intercommunication radio (Bluetooth in the preferred embodiment) has the capability to use the lowest power necessary to communicate with the next device in the chain. The sensor control modules are capable of self-determining the communication hierarchy necessary for each sensor control module to be capable of communicating both up and down this hierarchy to the sensor control modules above and below it in the communication chain. For sensitive and confidential information the radio communication may be encrypted. Also to reduce power necessary send a communication the message may be compressed and sent as a “burst”.

It is envisioned that this scattered sensor network could be asked to work in the types of severe environments that can cause shortened equipment life-spans and expected early failures. It is to be appreciated that the redundancy of the network components are important in these types of environments, where the failure of one device or multiple devices does not cause the entire sensing network to fail. In the types of environments where long range communication may not always be possible due to atmospheric conditions such as sunspots the data collected by the central collector (or back-up device) may be stored, ready for transmission when the conditions are right. For example, if satellite communications are desired the device may only send the data when the position of the satellite is optimal. Another time that the transmission of data may be delayed is when the communication frequency band being used for the transmission has traffic at its lightest.

In the case where the sensor control modules are both capable and likely to be moving it will be necessary to periodically determine the location of at least one sensor control module (if the relative position of the other sensor control modules stays fixed). If the sensor control module are possibly moving not only relative to the surface of the earth but also relatively to each other then it may also be necessary to access the position of each sensor control module using their own individual GPS components and determining the location of the non GPS equipped devices using the previously explained triangulation method.

The present invention has another capability. By using two GPS-enabled sensor control modules on the surface of an object of interest and communicating the position of those sensor control modules to a home base it is possible to track not only the location of the object but also its rotation. Using two GPS equipped sensor control modules each on two objects gives an interested party the information about not only the location and rotation of the objects but also what the orientation of the two objects is to each other.

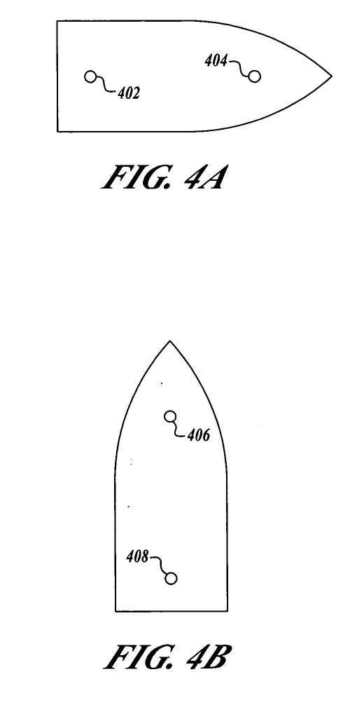

For example FIG. 4 shows objects such as two ships A and B, each with two GPS-equipped sensor control modules mounted fore and aft 402, 404, 406 and 408. Since the sensor control modules are uniquely identified so both the ship and the location on the ship may be determined. Tracking the position of each identified sensor control module gives not only each ships location but also the relative orientation of each ship to each other.

Other examples for using the present invention include the monitoring of ice flows where-in-as the position, direction and size (using, for example, as a sensing device a seismographic unit to measure its depth) may be determined and communicated. Other examples may be using the present invention to monitor potential Lahars in glaciated areas, or sensing the presence of humans in a remote or inaccessible area where interdiction is desired. By using sensors capable of detecting movement, heat, and vibration, migratory patterns may be determined.

Other examples may be where sensors are dropped in search and rescue zones to find those who may be lost; sensors may be scattered in migration paths to determine routes and numbers of those animals involved; sensors may be dropped or scattered in areas of high poaching activity to record and report gunshots or vehicle traffic.

The capability of the sensors to be randomly scattered across areas inaccessible or otherwise remote by using airplanes, helicopters, drones or other means, and having them capable of self-organizing, then sensing, collecting, analyzing and communicating data will find many more uses than disclosed here.

Therefore, although the invention has been described as setting forth specific embodiments thereof, the invention is not limited thereto. Changes in the details may be made within the spirit and the scope of the invention, said spirit and scope to be construed broadly and not to be limited except by the character of the claims appended hereto.

1. A distributed sensor network comprising:
a) two or more sensors associated with two or more sensor control modules, said sensor control modules capable of short range wireless communication with each other;
b) location means for determining the reasonably exact location of each sensor control module in the sensor network; and
c) communication means associated with at least one sensor control module for communicating sensor data to a remote facility.

2. The distributed sensor network of claim 1 wherein the at least one sensor control module containing the communication means for communicating sensor data to a remote facility further includes a processing capability to collect and analyze said sensor data.
